(19) United States
(12) Patent Application Publication
(10) Pub. No.: US 2016/0289108 A1
(43) Pub. Date: Oct. 6, 2016

(54) PROCESS FOR TREATMENT OF PRODUCTION WATER USING POLYOLS

(71) Applicant: Water Water, Inc., Bakersfield, CA (US)

(72) Inventors: STANLEY ELLIS, Bakersfield, CA (US); GLENN RICHARDS, Bakersfield, CA (US)

(21) Appl. No.: 14/677,738

(22) Filed: Apr. 2, 2015

(51) Int. Cl. C02F 9/00; C02F 1/28; C02F 1/40; C02F 1/44

(52) U.S. Cl. CPC C02F 9/00; C02F 1/441; C02F 1/283; C02F 1/40; C02F 2301/08; C02F 2101/32

(57) ABSTRACT

An economical method to remove oil, silica, boron, arsenic and selenium from water produced from oil production or fracking operations. The pH is not altered during the process and post method water quality is sufficiently pure for irrigation use and use as potable drinking water. The method includes using filtration to reduce the size of the inorganic and organic undissolved solids to a size of particulates of less than 2 microns, removal of oil with a micro-oil droplet separator followed by pre-activated charcoal, treatment of boron with a selective group of polyols, and reverse osmosis.

### FIELD OF THE INVENTION

This description relates to the field of treatment of production water recovered from the ground during oil and gas production operations. More specifically, the present invention relates to methods of treating production water for oil, total dissolved solids, and metals such as boron and silica such that the treated production water can be used either in irrigation or as potable drinking water.

### BACKGROUND OF THE INVENTION

Water produced during oil and gas extraction operations is the industry's current largest waste product. There are estimates of 14 billion barrels of production water created annually by oil and gas extraction operations that most of which is considered to be unusable waste.

The produced water always contains some oil, both physical free oil and dissolved oil. In addition to the presence of oil, production water often also contains large volumes of organic and inorganic suspended solid particulates and dissolved solids. Total dissolved solids (TDS) can include calcium, phosphates, nitrates, sodium, potassium and chloride. Production water also includes potentially harmful metals such as boron, selenium, arsenic, and strontium. Boron in particular is toxic to many crops and often needs to be controlled to low levels in irrigation water. The combination of oil, high TDS, and harmful substances has proven extremely costly for sufficient removal to enable the production water to be useable in any form. As a result, the standard practice of the oil and gas industry is simply to inject the production water into the ground as a means of disposing of the production water. Billions of barrels of production water are essentially wasted.

In many places on earth, there is no available clean water for human or agricultural consumption. Public water supplies, once plentiful, are now rapidly diminishing in quantity and likewise diminishing in quality. Thus, there is a great need for a cost effective treatment of production water that meets requirements of purity for beneficial uses such as irrigation, animal consumption and potable drinking water.

The oil and gas industry itself also has need for access to a clean water supply. Initial oil extraction operations were premised on finding pockets of pressurized oil near the surface. As these early supplies of pressurized surface oil were consumed, oil extraction operations began to inject steam into more difficult to extract oil deposits in order to remove oil underground and force it to the surface. The presence of oil, high TDS, and certain metals that cause scaling such as calcium and silica render production water unusable as steam. Therefore, the oil and gas industry would be financially benefited by inexpensive and effective production water treatment process to enable the treated production water to be re-used in down-hole oil and gas extraction activities, as well as for agricultural purposes.

### There are Numerous Challenges to Cost Effectively Treat Production Water.

1. Oil

During the production process, oil is separated from the production water. However, not all the oil is separated from the production water during the production process. In addition to the remaining oil, other solvents are also present in the production water after oil water separation occurs in the field. The presence of oil in the production water greatly affects down-stream filtration components.

Conventional water treatment systems using reverse osmosis, reverse osmosis with UF (Ultra Filtration) and NF (Nanofiltration) or HERO (High Efficiency Reverse Osmosis) will quickly degrade as they plug with microscopic oil droplets. Reverse osmosis is a separation process that uses pressure to force a solvent (water) through a semi-permeable membrane, which retains the solute (contaminant) on one side and allows the pure solvent (water) to pass to the other side. The membrane is semi-permeable, meaning it allows the passage of solvent (water) but not solute (contaminant).

Reverse osmosis filters require less than 0.1 ppm of oil in the production water to avoid oil induced membrane failures. Typical oil water separators used in oil and gas production are rated for 10 ppm and thus result in produced water that is far too oil rich for effective use of conventional water treatment systems. Similarly, activated carbon filters will quickly saturate with production water having 10 ppm of oil and will require frequent replacement and will fail to remove all the oil and other solvents present. Thus, the presence of oil greatly affects the quality of water treatment in conventional systems and adds a great deal of additional operational expense because filters require constant replacement or cleaning. Agricultural water and portable drinking water both require non-detectable amounts of oil. Thus, removal of all oil from the production water is essential to enable use of the treated production water in agriculture or as potable drinking water.

2. Presence of Harmful Metals

Boron, arsenic, selenium, strontium and other metals are often present in the subsurface zones where hot water or steam is being injected. Federal and state law requires boron to be below 0.5 ppm and selenium to be below 20 ppb in water used in irrigation or as potable drinking water. Boron is particularly challenging to remove in reverse osmosis systems. Reverse osmosis membranes struggle to removal neutral contaminants, such as boron.

In aqueous environments, boron is mainly present as undissociated boric acid at acidic and neutral pH. Uncharged boric acid has a molecular diameter of 2.75 A and is therefore much smaller than the more easily reverse osmosis filtered hydrated sodium (3.58 A) and chloride (3.32 A). Therefore reverse osmosis membranes are better at removing charged species over uncharged species due to the larger size of hydrated charged species.

When the boron level in water exceeds 2 ppm, reverse osmosis systems often fail to reduce the boron level to below the target 0.5 ppm. Boron levels in produced water often ranges from 2 to 85 ppm rendering conventional reverse osmosis systems incapable of reducing the boron content sufficiently for use in irrigation. High efficiency reverse osmosis systems are more effective at removing boron, but require operation in a high pH (high alkali) range. Produced water is typically pH neutral. Any system using a high efficiency reverse osmosis system first must raise the pH of the produced water prior to passing the water through the reverse osmosis filter and then return the pH back to neutral. Typically, reverse osmosis is used in combination with a high pH level of 10.5 of greater. The process of raising and lowering the pH on a large scale treatment process substantially adds to the operational costs of water treatment systems utilizing high efficiency reverse osmosis filters. Even use of a high efficiency reverse osmosis system still requires multiple passes through the reverse osmosis filter or the addition of clean water to further dilute the treated production water to ensure boron concentrations of below 0.5 ppm are achieved. Additional passes through the reverse osmosis membrane and dilution procedures further add to the costs of production water treatment.

3. High Temperature

The common use of injected steam and deeper wells results in production water that is hot when brought to the surface, ranging in temperature from 110° F. to 185° F. The high temperature of the water further impedes efficient water treatment because the hot water quickly degrades much of the equipment used in known treatment processes, such as those using tubular polymeric membranes. Expending energy to cool large volumes of water is extremely costly and further adds to the challenges of large scale production water treatment processes.

### SUMMARY OF THE INVENTION

This invention is directed to a cost effective method of treating production water high in total dissolved solids, oil, and harmful metals such as boron, without altering the pH of the production water.

In one illustrative embodiment, production water is treated in two basic steps. First, the oil is removed from the production water. Second, the boron is removed from the production water using one or more polyols selected from the group of D-mannitol, sorbitol, n-methyl-D-glutamine, maltitol, lactitol, erythritol, isomalt and xylitol.

### Oil Removal

First, the production water is passed through a series of filters to filter inorganic and organic undissolved solid particulates from the production water leaving only undissolved solid particulates of 2 microns or less in size remaining in the production water. A variety of filters can be used in combination, including nutshell filters, sock filters, cartridge filters, oil absorption filters and pleated filters.

Second, the production water is passed through a micro-oil droplet separator to reduce oil content to less than 0.1 ppm. The micro-oil droplet separator's effectiveness at removing oil is maximized by first removing all inorganic and organic undissolved solid particulates of greater than 2 microns in size. The oil recovered from the micro-oil droplet separator can be aggregated and stored in an oil recovery tank to add to oil production yields.

Third, the production water is passed through pre-activated charcoal, coal or carbon. The production water exiting the micro-oil droplet separator may still have trace elements of oil. The passing of the production water through pre-activated charcoal ensures the absorption of the remaining trace oil. If the micro-oil droplet separator is not used upstream from the pre-activated charcoal, the pre-activated charcoal would quickly saturate with oil and require frequent replacement.

### Boron Removal

Polyols selected from the group of D-mannitol, sorbitol, n-methyl-D-glutamine (nmDg), maltitol, lactitol, erythritol, isomalt and xylitol are injected into the production water at a molar ratio of 1:1 to 10:1 polyol to boron. The molar ratio of polyol to boron is typically at least about 1:1 and no more than 10:1; preferably is at least about 1:1 to and no more than 5:1; and most preferably 1:1 to 2:1. Polyols are alcohols containing multiple hydroxyl groups. The polyols identified above are particularly suited to complex or covalent bond with boron present in the form of boric acid at neutral pH. The above polyols are effective in complexing with boron either alone or in combination. Polyol blends including one or more of the polyols set forth above are cheaper to manufacture than a single polyol, and therefore it may be advantageous to use more than one polyol from the above group or at a minimum a blend of polyols that include one or more of the polyols form the above group.

Conventional treatments for removal of boron employ chemical additives to raise the pH of the production water sufficiently to convert the non-ionized boric acid B(OH)₃ to the borate monovalent anion B(OH)₄⁻. Reverse osmosis filters are more efficient at removing the negatively charged borate monovalent anion. In such a conventional system, more chemicals are required to be added post reverse osmosis to lower the pH back to neutral. In addition, conventional treatments also require the addition of non-production water with low boron concentrations to further dilute the boron concentration of the production water.

The use of the selected polyols in the molar concentrations disclosed above eliminates the need to adjust the pH of the production water or dilute the production water. More specifically, the selected polyols complex with the boric acid at neutral pH to form borate-polyol complexes with much larger atomic weight and size compared to the small atomic weight and size of boric acid. As a result, conventional single stage reverse osmosis filter systems can easily reject the resulting larger borate-polyol complexes.

In an alternative embodiment, the pre-activated charcoal can be soaked in one or more of the polyols selected from the group of D-mannitol, sorbitol, n-methyl-D-glutamine (nmDg), maltitol, lactitol, erythritol, isomalt and xylitol. In so doing, the boric acid present in the production water will complex with the polyols present in the pre-activated charcoal. The resulting larger borate-polyol complexes are then absorbed by the pre-activated charcoal. In this embodiment, no reverse osmosis is required, however, the pre-activated charcoal will require more frequent replacement.

The nutshells in a nutshell filter can also be soaked in one or more of the polyols selected from the group of D-mannitol, sorbitol, n-methyl-D-glutamine (nmDg), maltitol, lactitol, erythritol, isomalt and xylitol in lieu of soaking the pre-activated charcoal in the same. The resulting larger borate-polyol complexes will be filtered in part by the nutshell filter and absorbed in part by the pre-activated charcoal.

Although soaking either the nutshells or pre-activated charcoal eliminates the requirement of a reverse osmosis filter for the removal of boron, reverse osmosis filters may still be utilized in order to remove other contaminants and lower the total dissolved solids present in the production water. Thus, elimination of the reverse osmosis step is only preferred when the total dissolved solids in the production water is low.

### Silica

The presence of colloidal silica in production water in concentrations ranging from 60 ppm to 400 ppm may require an additional step for use in combination with the embodiments disclosed above. Without adding an additional processing step, the colloidal silica will foul reverse osmosis membranes.

One option for the treatment of colloidal silica is to inject sodium aluminate upstream from the micro-oil droplet separator. The sodium aluminate is injected on a molar basis of 2:1 to 6:1 sodium aluminate to silica. The sodium aluminate forms a large white precipitate at least 100 microns in size that can easily be filtered with a mechanical separation filter.

A second option for the treatment of colloidal silica in combination with the methods disclosed above is to pass the production water through an electro-positive diatomaceous earth filter with a coating of aluminum oxide.

A third option is to inject an antiscalant material is injected into the production water prior to reverse osmosis. Such antiscalants are typically blends of polyacrylic acid and polycarboxylates and are well known in the art for preventing silica scaling on reverse osmosis membranes.

### BRIEF DESCRIPTION OF THE DRAWING

The nature, objects, and advantages of the present invention will become more apparent to those skilled in the art after considering the following detailed description in connection with the accompanying drawings, in which like reference numerals designate like parts throughout, and wherein:

FIG. 1 depicts the sequence of steps for the removal of oil from production water prior to treatment for any other contaminant;

FIG. 2 depicts the sequence of steps for the removal of boron through use of polyols;

FIG. 3 shows boric acid passing through semi-permeable membrane of conventional reverse osmosis filter;

FIG. 4a shows boric acid complexing with the polyol xylitol to form larger xylitol complexes that cannot pass through the apertures of a semi-permeable reverse osmosis membrane;

FIG. 4b shows boric acid complexing with the polyol nmDg to form larger nmDg complexes that cannot pass through the apertures of a semi-permeable reverse osmosis membrane;

FIG. 5 shows an embodiment of a downstream processing system for the treatment of produced water having oil, high boron, low silica and high TDS and incorporating the method sequences set forth in FIGS. 1 and 2 above;

FIG. 6 shows an added process step to the process disclosed in FIG. 5 in which an antiscalant is injected into the production water;

FIG. 7 shows an alternative process step to remove silica through use of injected sodium aluminate and precipitate filter;

FIG. 8 shows an alternative process step to remove silica prior to reverse osmosis through use of a DE filter; and

FIG. 9 shows an alternative process with a pre-activated charcoal impregnated with a polyol blend and without utilizing reverse osmosis.

### DETAILED DESCRIPTION OF A PREFERRED EMBODIMENT

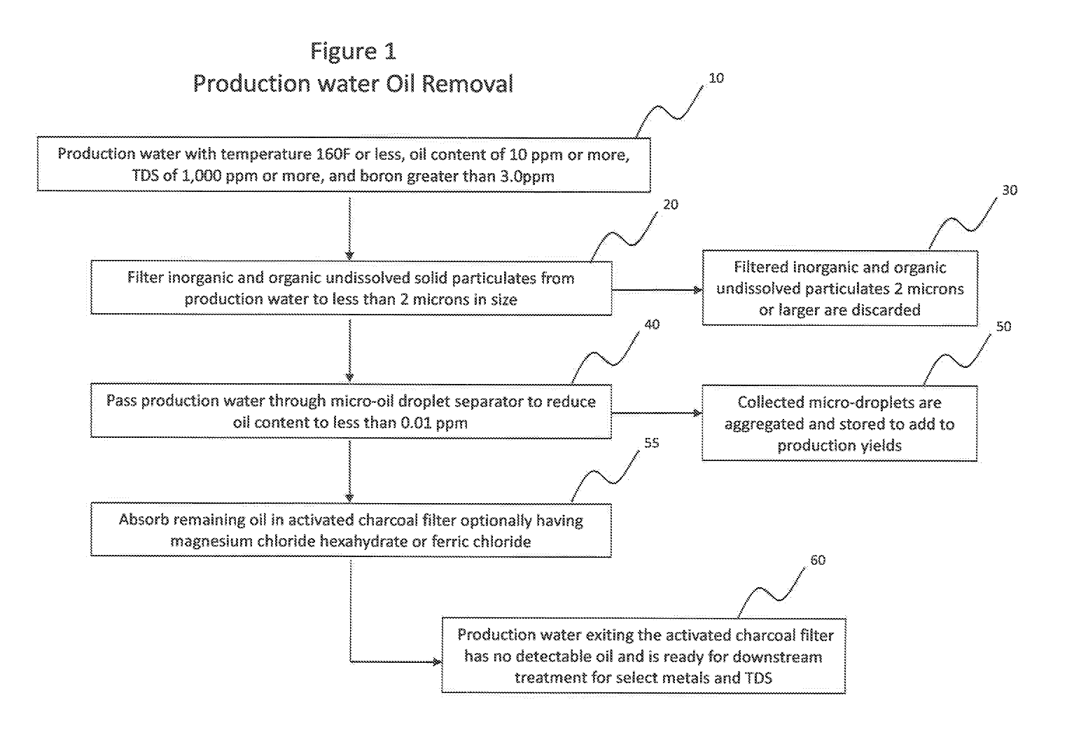

Referring initially to FIG. 1, the process steps for removing oil are shown and generally described. Production water 10 typically having a temperature of 112° F. or less, oil content of 2 ppm or more, TDS of 600 ppm or more, and boron content more than 2 ppm is ready for treatment according to the method disclosed herein. The production water 10 has already been passed through industry standard oil water separation units that were incapable of fully removing the oil and other harmful solvents.

The production water 10 must be placed through a filter step 20 whereby inorganic and organic undissolved solid particulates are removed from the production water 10. The filter step 20 removes all inorganic and organic undissolved particulates 2 microns in size or larger using one or more filters. In a preferred embodiment, the inorganic and organic undissolved solid particulates are passed through an array of filters gradually increasing filtering capacity. The collected inorganic and organic undissolved particulates are discarded in a first waste disposal 30. Typically, the inorganic and organic undissolved solid particulates discarded in the first waste disposal 30 are discarded along with the various filter elements when those filter elements are ready for replacement.

Next, the production water 10 have inorganic and organic undissolved solid particulates of less than 2 microns in size is passed through oil filtration step 40. The oil filtration step 40 separates micro droplets of oil and other solvents from the production water 10 and aggregates into an oil storage 50. The oil filtration step 40 reduces the content of the oil in the production water 10 to between less than 0.01 and 0.3 ppm oil.

The production water 10 is next passed through a second filter step 55 whereby the production water 10 is polished through one or more activated charcoal filters having magnesium chloride hexahydrate or ferric chloride. The activated charcoal absorbs the remaining oil and other solvents such that the production water 10 leaving the activated charcoal filters has non-detectable oil resulting in oil free production water 60. The oil free production water 60 is ready for downstream treatment for select metals such as metals and for the reduction of TDS. Regardless of the TDS content, boron content, or silica content, the removal of oil from the production water 10 will follow the steps set out in FIG. 1 prior to treatment for TDS, boron, or silica.

The particular process utilized for treatment of the oil free production water 60 requires a preliminary analysis of the composition of the produced water. The composition of water various greatly on the source of the produced water. Prior to removing oil according to FIG. 1, the production water 10 should be examined to determine the concentrations of boron, silica, arsenic and total TDS. Once the production water 10 is examined to determine the concentrations of the above components, then the proper treatment process can be selected and used following the oil removal process.

Production Water with Oil, High Boron, Low Silica High TDS

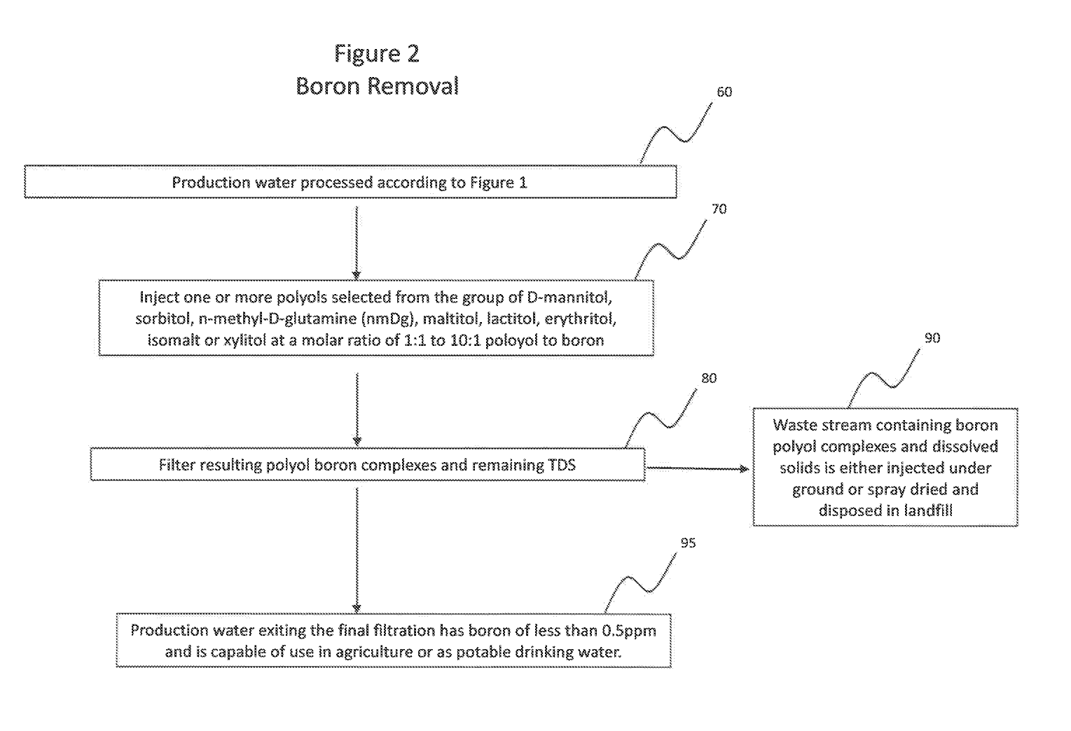

First, the oil is removed according to the process described in connection with FIG. 1 above. Next, referring to FIG. 2, the oil free production water 60 is subjected to a polyol injection step 70. During the polyol injection step 70, one or more polyols selected from the group of D-mannitol, sorbitol, n-methyl-D-glutamine (nmDg), maltitol, lactitol, erythritol, isomalt and xylitol at a molar ratio ranging between 1:1 to 10:1 polyol to boron is injected directly into the oil free production water 60. As stated above, the range of molar ratio of polyol to boron is typically at least about 1:1 and no more than 10:1; preferably is at least about 1:1 to and no more than 5:1; and most preferably 1:1 to no more than 2:1. After the polyol injection step 70, the oil free production water 60 is passed through a final filtration step 80 whereby the dissolved solids and boron is filtered from the oil free production water 60 into the waste stream 90. The resulting oil free production water 60 is capable of use in agriculture or as potable drinking water 95.

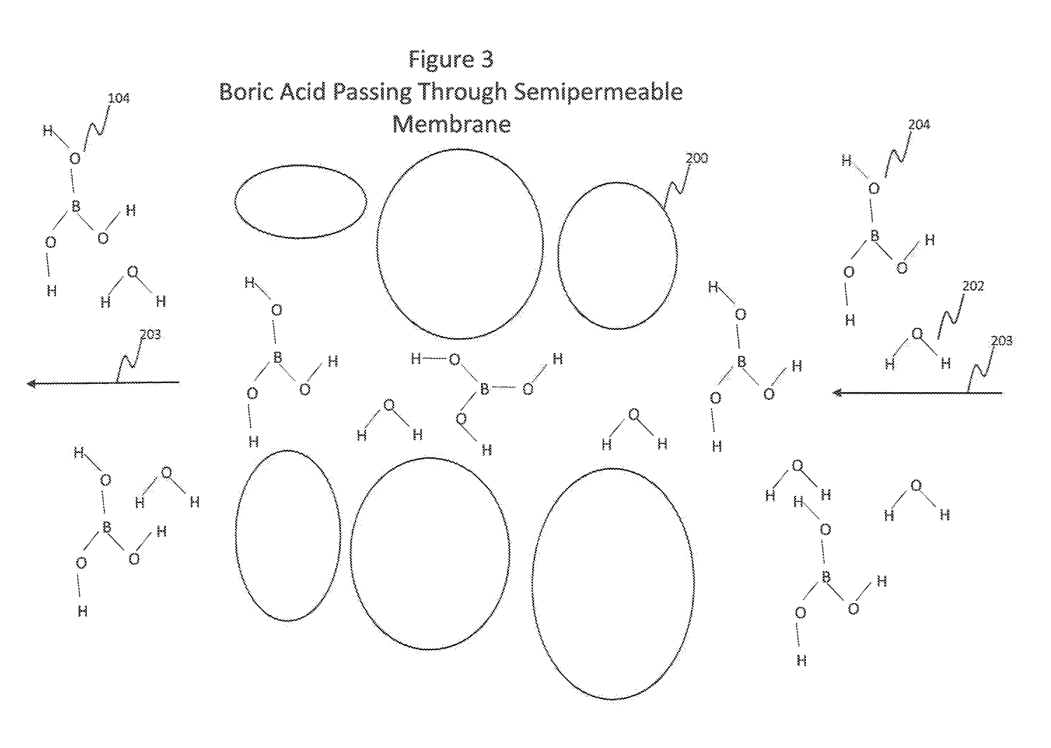

The polyol injection step 70 is required prior to filtering to reduce TDS. Conventional filtering of TDS is performed using reverse osmosis filters. Reverse osmosis filter membranes struggle to filter Boron. Turning to FIG. 3, a partial cross-sectional view of a semi-permeable membrane 200 is shown with oil free production water 60 having water molecules 202 and boric acid molecules 204 and traveling in downstream direction 203. Both the water molecules 202 and the boric acid molecules 204 are small and easily pass through the semi-permeable membrane 200 of a typical reverse osmosis filter (omitted from view for scale purposes).

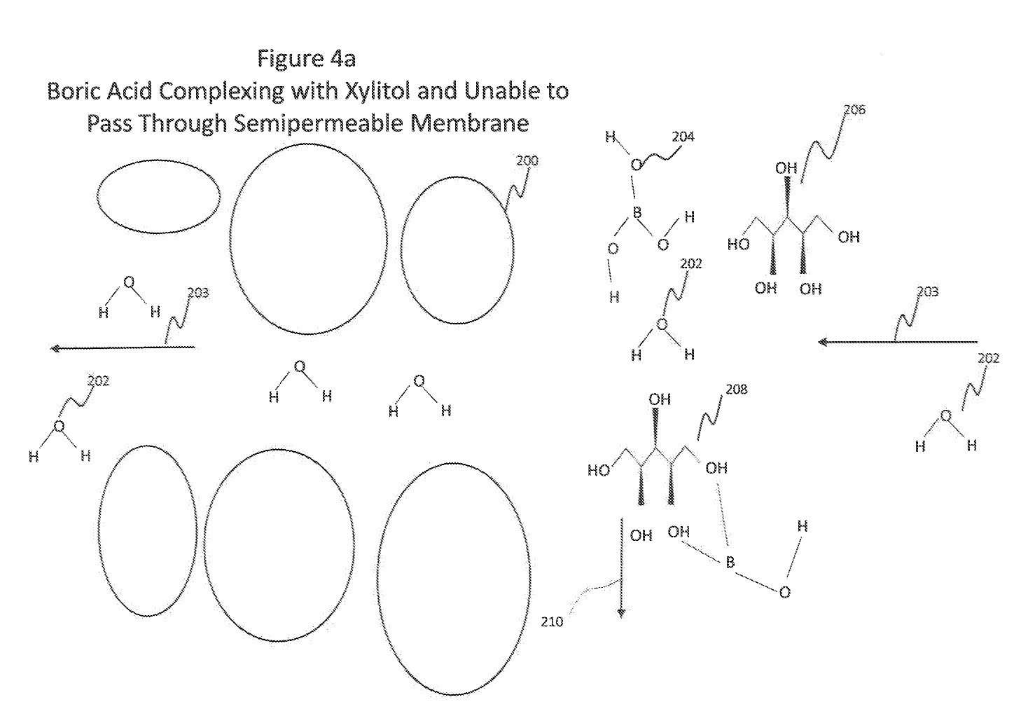

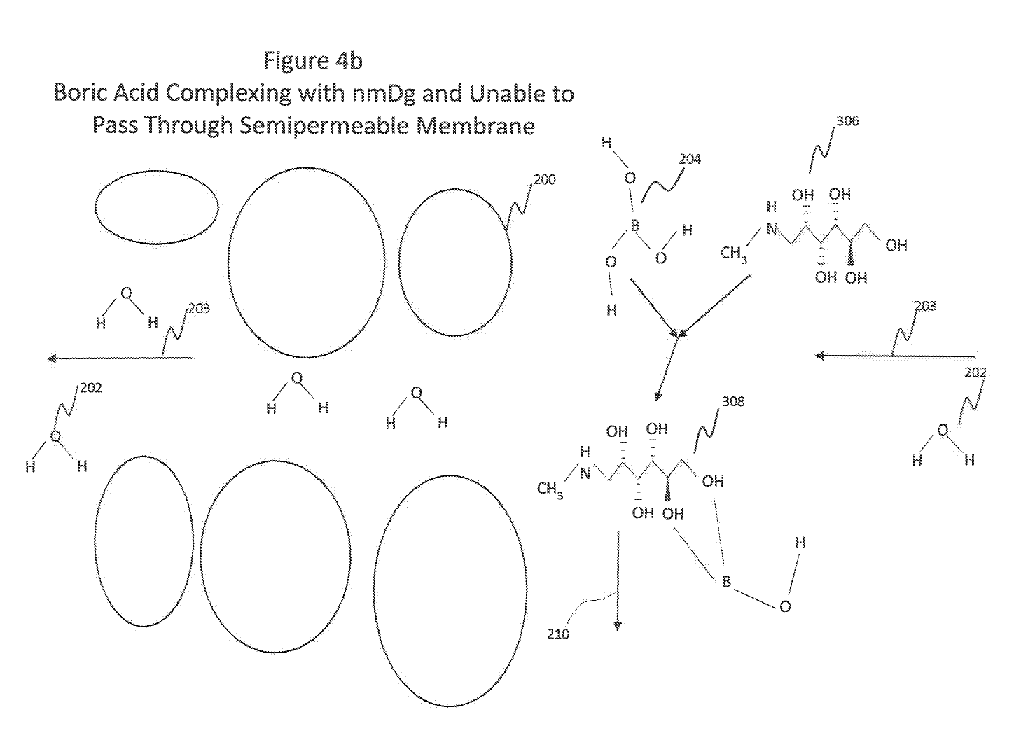

The benefit of the polyol injection step 70 is shown in FIGS. 4a and 4b. Boric acid/borate reacts with chemical compounds containing multiple hydroxyls groups (polyols), such as xylitol and nmDg, generating anionic complexes at the neutral pH of water. Schematic drawings of xylitol and nmDg and their corresponding negatively charged borates—xylitol and nmDg complexes are shown below and in FIGS. 4a and 4b.

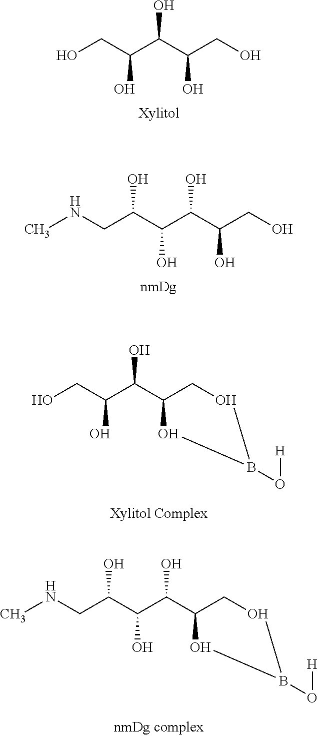

As shown in FIG. 4a, water molecules 202 and boric acid molecules 204 are present in the production water 10 moving in downstream direction 203. Xylitol molecules 206 injected into the production water 10 complex with the boric acid molecules 204 to form resulting borate—xylitol complexes 208 that are much larger in atomic weight and size compared to the boric acid molecules 204. As a result, the borate—xylitol complexes 208 are easily rejected by the semi-permeable membrane 200 of the reverse osmosis filter and are thereafter directed to a waste stream 210. In contrast, the water molecules 202 easily pass through the semi-permeable membrane 200. As a result, the production water 10 that passes through the semi-permeable membrane 200 is substantially boron free. The pH is unaffected by the complexing process and/or covalent bonding between the boric acid molecules 204 and the xylitol molecules 206 and the pH of the production water 10 remains neutral.

Similarly, as shown in FIG. 4b, nmDg molecules 306 injected into production water 10 moving in downstream direction 203 complex with the boric acid molecules 204 to form resulting borate—nmDg complexes 308. The resulting borate—nmDg complexes 308 that are formed are negative in charge and much larger in atomic weight compared to the boric acid molecules 204. As a result, the borate—nmDg complexes 308 are easily rejected by the semi-permeable membrane 200 of the reverse osmosis filter 150 (not shown). The rejected borate—nmDg complexes 308 are directed to waste stream 210.

The waste stream 210 is then injected into the ground 170 (not shown) per conventional processes typically used in the oil and gas industry. Alternatively, the waste stream 210 can be spray dried, collected, and disposed according to local disposal laws.

Not all polyols complex well with boric acid. Thus, an embodiment of this invention is to utilize a combination of polyols from the group of D-mannitol, sorbitol, n-methyl-D-glutamine (nmDg), maltitol, lactitol, erythritol, isomalt or xylitol. A blend of polyols selected from the above polyol group provides a lower cost alternative to simply using only one of the above listed polyols to complex with the boric acid. It is to be appreciated that use of only one of the polyols selected from the above polyol group is effective

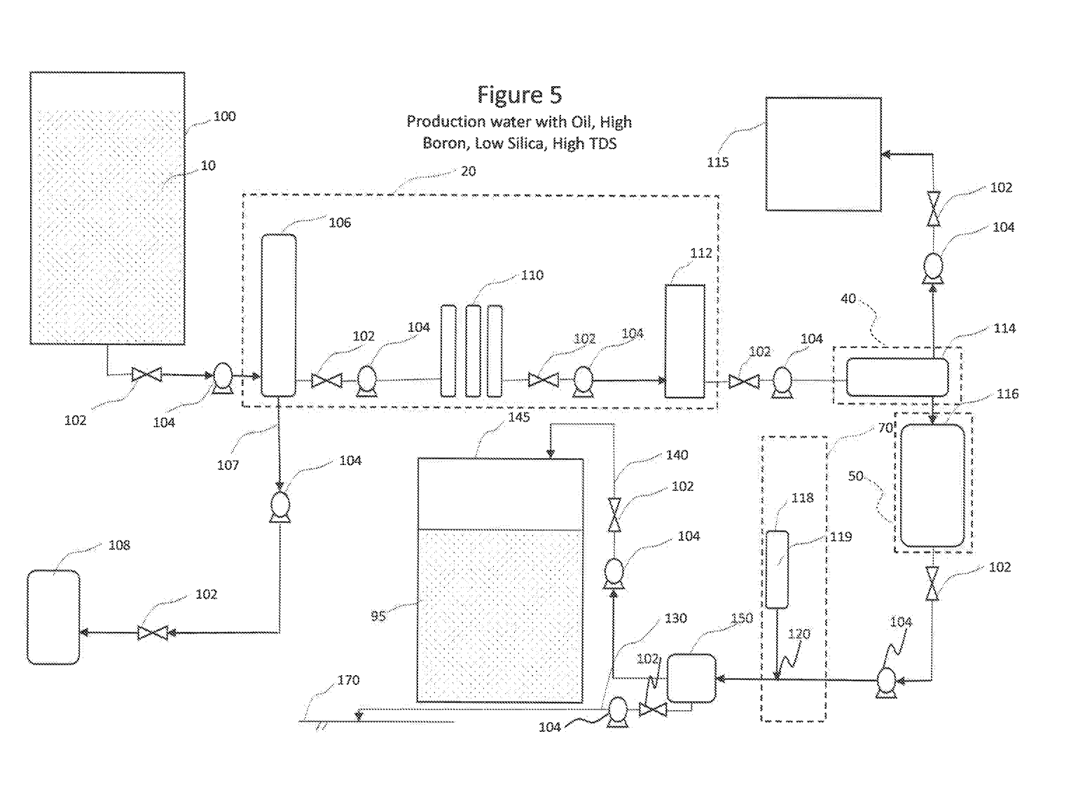

Referring initially to FIG. 5, a process for treating production water 10 with oil, high boron, low silica and high TDS is generally shown. Production water 10 is first stored in a large storage tank 100. Production water 10 typically has high total dissolved solids, high concentrations of boron and silica, and oil. It is preferred to have the production water 10 stored in the storage tank 100 for a sufficient period of time to enable the temperature of the production water 10 to drop below 112° F. Alternatively, cooling fins can be used in combination with system piping used to transport production water 10 to and from the storage tank 100 to more quickly cool production water 10. The pH of production water 10 is typically 7.0. Prior to entering the storage tank 100, the production water 10 has already been passed through a conventional oil water separator (not shown). However, the stored production water 10 has remaining oil, typically in an amount of 2 ppm. This oil quickly coats reverse osmosis membranes used in conventional water treatment applications and must be removed prior to any reverse osmosis.

The production water 10 is first transferred to a nutshell filter 106 by way of a pump 104. A valve 102 can be used to control the flowrate of the production water 10 into the pump 104. The nutshell filter 106 is typically comprised of nut shells such as walnut or pecan, ground to a fine consistency and stacked in one or more columns. The nutshell filter 106 will absorb trace amounts of oil and will generally filter larger inorganic and organic particulates. The production water 10 exiting the nutshell filter 106 is typically 1 to 2 ppm oil, with inorganic and organic particulates of less than 20 to 30 microns in size. Boron levels, silica levels and total dissolved solids levels remain the same after passing through the nutshell filter 106. The pH level is also unaffected by the nutshell filter 106 and remains neutral at approximately 7.0. The larger inorganic and organic materials are filtered by the nutshell filter 106 into a waste stream 107 that is directed to a disposal tank 108.

Next, the production water 10 is passed through one or more sock filters 110 reducing the inorganic and organic particulates to less than 10 microns in size. The production water 10 next is passed through one or more cartridge filters 112 further reducing the inorganic and organic particulates to less than 2 microns in size. It is to be appreciated by those skilled in the art that pleated filters 111 (not shown) can be used in lieu of or in combination with sock filters 110 and cartridge filters 112. The combination of sock filters 110, pleated filters 111 or cartridge filters 112 should reduce the size of particulates present in the production water 10 to 2 microns or less.

The combination of nutshell filters 106, sock filters 110, pleated filters 111 and or cartridge filters 112 are all part of filter step 20 as described above in connection with FIG. 1. Reduction of the particulates to 2 microns or less during filter step 20 is required prior to the down-stream oil filtration components. The pH of the production water 10 exiting the filter step 20 remains unaffected and neutral.

The production water 10 is next passed through a micro-oil droplet coalescer 114 in the oil filtration step 40. The micro-oil droplet coalescer 114 separates all materials with a specific gravity of less than 1.0, including oil and other solvents. The oil and other solvents separated from the production water 10 by the micro-oil droplet coalescer 114 are directed to oil recovery tank 115. The oil collected and stored in oil recovery tank 115 will increase the oil production yields and therefore further reduce costs of the methods disclosed herein. The production water 10 exiting the micro-oil droplet coalescer 114 only contains trace amounts of oil of 0.5 ppm or less. The pH of the production water 10 remains unaffected and neutral as the production water 10 passes through the micro-oil droplet coalescer 114. Reduction of the particulate size to less than 2 microns prior to entry into the micro-oil droplet coalescer 114 ensures that the micro-oil droplet coalescer 114 will function efficiently and effectively. Particulates larger than 2 microns will interfere with the formation of the micro-oil droplets and substantially reduce the effectiveness of the micro-oil droplet coalescer 114. Therefore, it is preferred to locate the micro-oil droplet coalescer 114 downstream from the various filters used in filter step 20.

The production water 10 is next passed through a pre-activated charcoal filter 116 filled with activated charcoal. The activated charcoal is manufactured by heating wood or nut shells to 500° F. to 572° F. for a short duration between 40 to 60 minutes in a hot air circulation oven, then cooled. During this heating process, the wood or nut shells burn to a fine charcoal. The cooled fine charcoal can be optionally soaked briefly in solutions of magnesium chloride hexahydrate or ferric chloride. The liquid water is removed from the cooled charcoal by a screen filter and then the remaining water solution and magnesium soaked charcoal granules are heated to 302° F. to 482° F. to evaporate any remaining water and activate the charcoal. In one embodiment of the present invention, the activated charcoal is manufactured from coconut shells. The pre-activated charcoal filter 116 is made by simply filling a stacked filter tube with the activated charcoal.

As the production water 10 passes through the pre-activated charcoal filter 116 the activated charcoal absorbs the remaining trace oil and solvents and reduces the particulates to less than one micron in size. In addition, the pre-activated charcoal filter 116 reduces total TDS by 10 to 30 ppm. The pH of the production water 10 remains neutral through the pre-activated charcoal filter 116. Further, the activated charcoal in the pre-activated charcoal filter 116 will not require frequent replacement because most of the oil and other solvents were removed upstream by the micro-oil droplet coalescer 114. The removal of the oil and other solvents upstream from the pre-activated charcoal filter 116 also increases the effectiveness of the pre-activated charcoal filter 116. The output of the pre-activated charcoal filter 116 is oil free production water 60.

The oil free production water 60 exiting the pre-activated charcoal filter 116 remains high in TDS and certain harmful metals such as boron, arsenic and selenium. As stated above, boron in production water 10 with neutral pH is typically in the form of boric acid H₃BO₃, which does not have an ionic charge and is therefore neutral. Further, as shown in FIG. 3, the atomic weight of boric acid is very small resulting in a small molecule that easily passes through the semi-permeable membrane 200 of a reverse osmosis filter 150. Therefore the oil free production water 60 is injected with a polyol blend 118 stored in a polyol at polyol injection point 120 during the polyol injection step 70. The polyol blend 118 selected form the group of D-mannitol, sorbitol, n-methyl-D-glutamine (nmDg) maltitol, lactitol, erythritol, isomalt and xylitol is injected at a molar ratio range of 1:1 to 10:1 polyol to boron. As stated above, the molar ratio range of polyol to boron is typically at least about 1:1 and no more than 10:1; preferably is at least about 1:1 to and no more than 5:1; and most preferably 1:1 to no more than 2:1. The polyol injection point 120 is shown upstream of reverse osmosis filter 150. It is to be appreciated by those skilled in the art that the polyol injection point 120 must occur upstream from the reverse osmosis filter 150 but is not required to be downstream from the pre-activated charcoal filter 116. In an alternative embodiment, the polyol injection point 120 is located upstream from the pre-activated charcoal filter 116 and downstream from the micro-oil droplet coalescer 114.

Returning to FIG. 5, after the polyol blend 118 is injected, the polyols complex with the boric acid present in the oil free production water 60 into borate—polyol complexes that are easily filtered by the reverse osmosis filter 150 into borate—polyol complex waste stream 130 during the final filtration step 80. The reverse osmosis filter 150 also filters the TDS from 3,000 ppm to less than 200 ppm. The oil free production water 60 that passes through the reverse osmosis semi-permeable membrane 200 (not shown) of the reverse osmosis filter 150 is potable drinking water 95 with TDS of less than 150 ppm and boron of less than 0.5 ppm. The potable drinking water 95 is suitable for agricultural use or human consumption and is directed into a fresh water stream 140 that terminates into a fresh water storage tank 160. The borate—polyol complex waste stream 130 is injected into the ground 170 for permanent disposal.

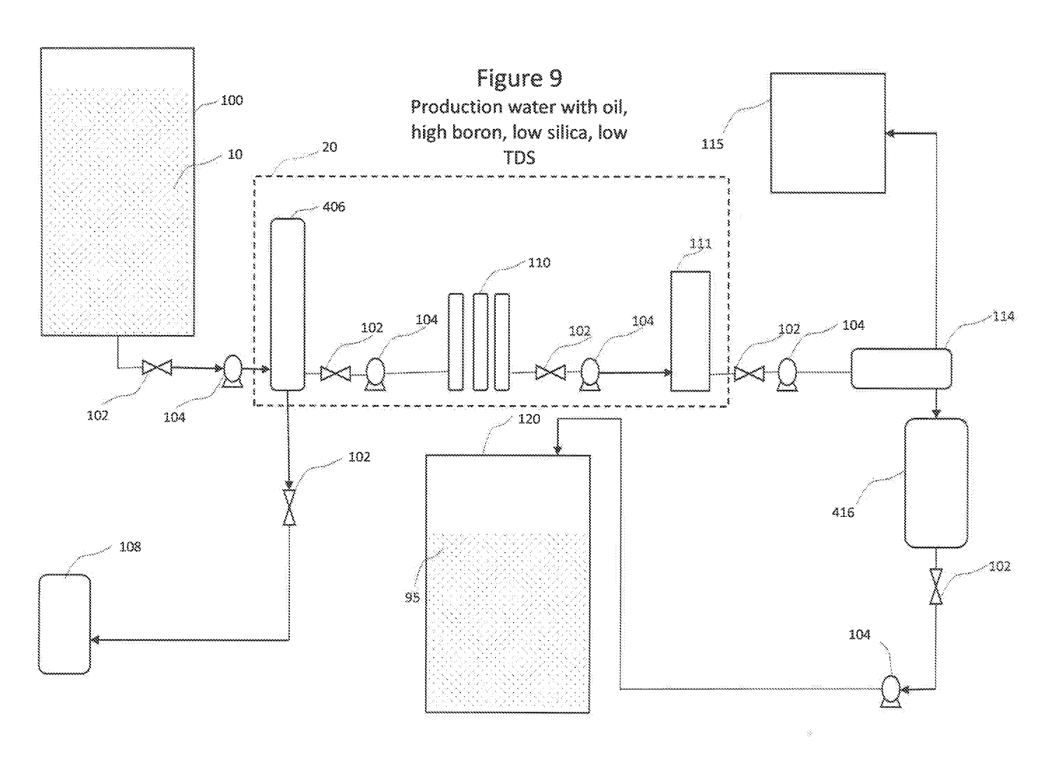

In an alternative embodiment, the polyol injection step 70 can be accomplished by adding polyols to the pre-activated charcoal as described in connection with FIG. 9 below.

### Oil, High Boron, High Silica, High TDS

If silica is present in the production water 10, it typically ranges from 60 to 400 ppm and is colloidal. Such amounts of silica will create a scale on the reverse osmosis semi-permeable membrane 200. More specifically, silica fouls reverse osmosis membranes by polymerizing into longer chains that form a gel-like substance that coats the membranes. As the silica scale builds, the reverse osmosis semi-permeable membrane 200 will lose its ability to pass water until the membrane fails entirely. Thus, it is necessary to either reduce silica content to below 30 ppm to prevent scaling or otherwise use an antiscalant typically in a concentration of 5 to 15 ppm.

The colloidal silica particles are less than 0.04 microns in size making sedimentation filtration extremely difficult.

### Sodium Aluminate

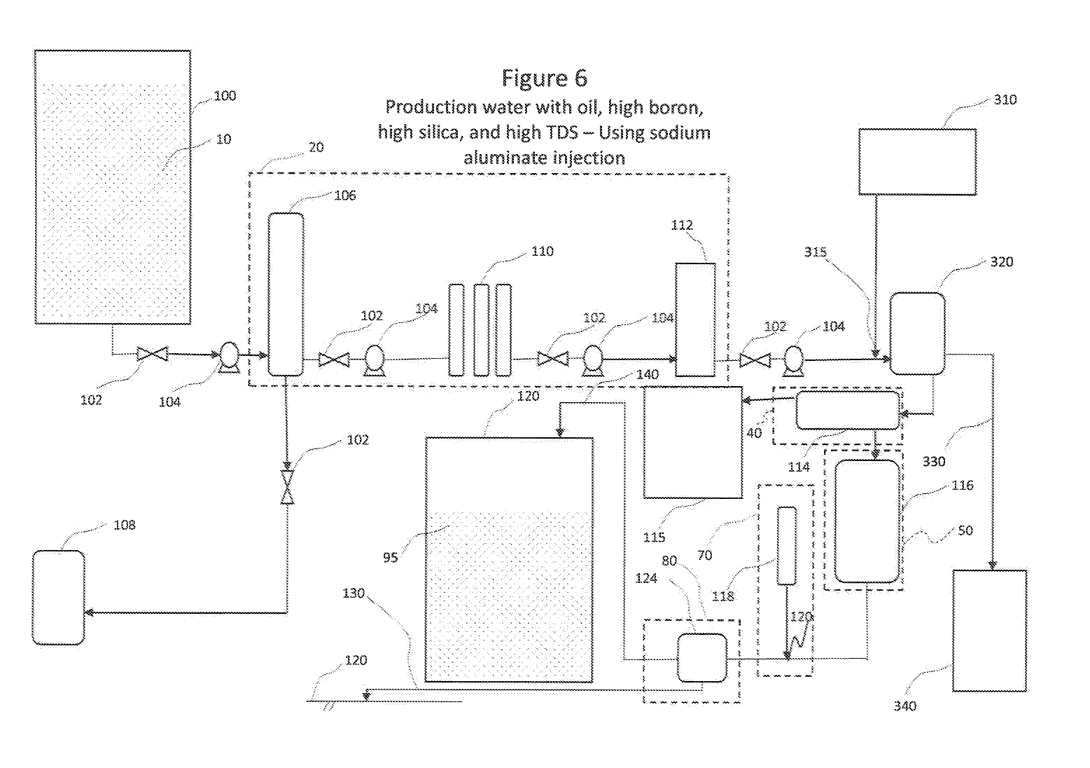

Referring to FIG. 6, a process to remove silica is used in connection with the water treatment process disclosed in FIG. 5. As shown in FIG. 6, upstream from the micro-oil droplet separator 114, sodium aluminate 310 is injected at sodium aluminate injection point 315.

The sodium aluminate 310 is injected into the production water 10 to form a precipitate large enough to be filtered by the mechanical separation. The sodium aluminate 310 is injected on a molar basis range of 2:1 to 6:1 on a molar basis of sodium aluminate 310 to silica. The sodium aluminate 310 forms a white precipitate with the silica that is at least 100 microns in size and is therefore significantly larger than the colloidal silica. The formed white precipitate can then be filtered with a mechanical separation filter 320 such as a centrifuge, plate and frame filter or other mechanical filtration method such as filter presses. Powdered activated charcoal can also be added to remove the silica precipitate.

Injection of sodium aluminate 310 in the ratio range set forth above coupled with the subsequent polyol injection step 70 and final filtration step 80 results in production water 10 with silica concentrations of less than 5 ppm, which is within acceptable limits for agricultural use or for use as potable drinking water 95. It is to be appreciated that an additional filter, such as a micro-filter can be utilized downstream from the sodium aluminate injection point 315 and upstream from the reverse osmosis filter 124 to filter the white precipitate.

### Electro-Positive Diatomaceous Earth

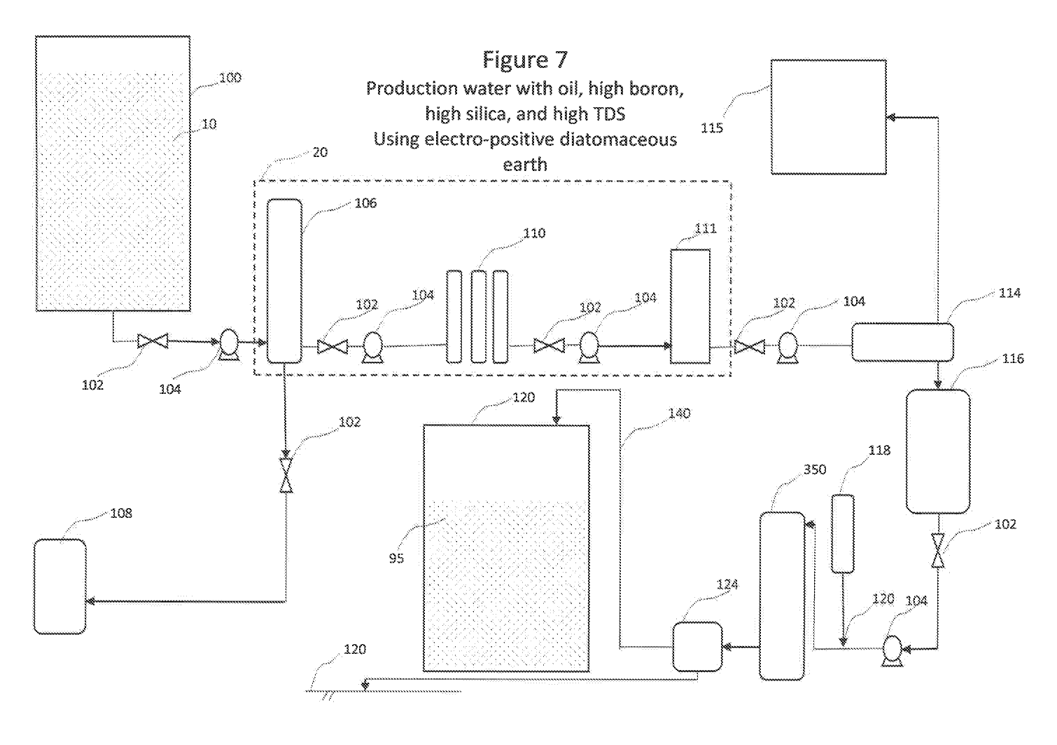

Referring next to FIG. 7, an alternative method for removing silica is shown. FIG. 7 shows a diatomaceous earth filter 350 downstream from the polyol injection point 120 and upstream from the reverse osmosis filter 150. More specifically, the diatomaceous earth filter 350 is filled with electro-positive diatomaceous earth with a coating of aluminum oxide-hydroxide. The silica colloidal particles in the production water 10 are negatively charged and are strongly attracted to the positively charged diatomaceous earth coated with aluminum oxide-hydroxide. The production water 10 exiting the diatomaceous earth filter 350 has silica concentrations of less than 30 ppm. During the filter step 20, a pleated filter 111 is shown in lieu of cartridge filters 112.

### Antiscalant

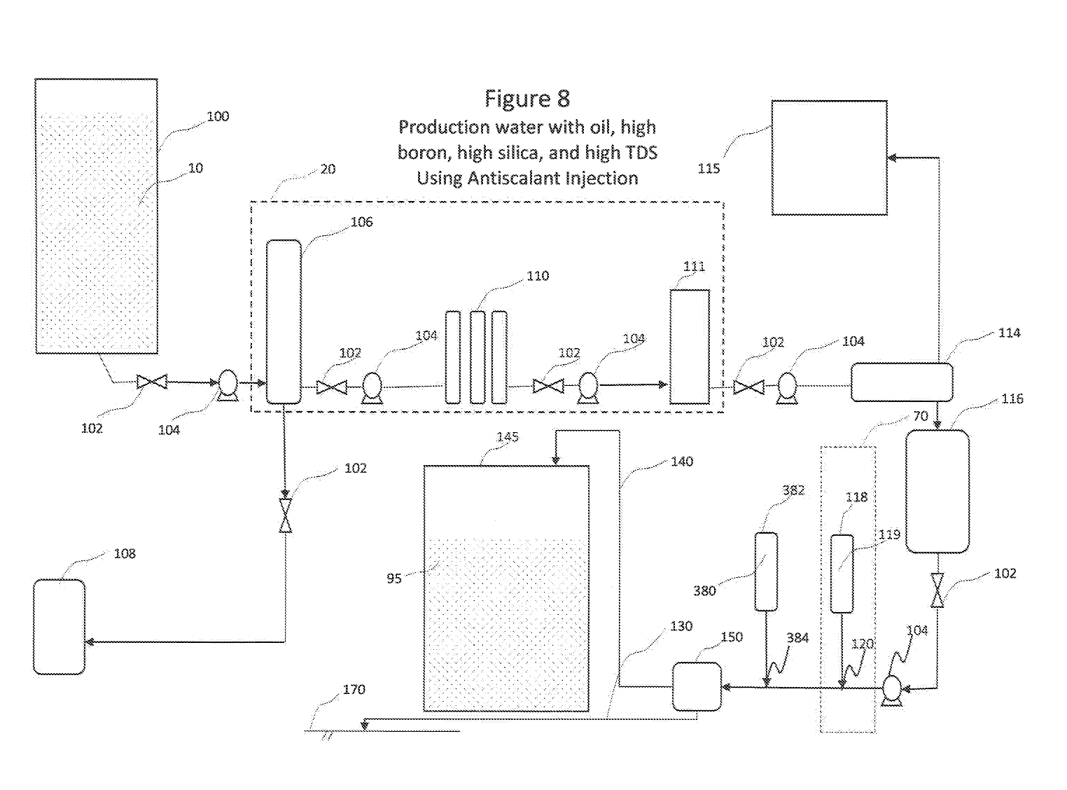

Referring next to FIG. 8, an antiscalant 380 is stored in an antiscalant reservoir 382 and injected at antiscalant injection point 384 into the production water 10 downstream from the polyol injection point 120. The antiscalant 380 prevents the formation of a silica film on the reverse osmosis semi-permeable membrane 200 (not shown) within the reverse osmosis filter 150 by impeding nucleation of silica atoms in the liquid phase. The antiscalant 380 preferably is a mixture of polyacrylic acid and polycarboxylates. Such antiscalants are well known in the art and there are numerous third party proprietary antiscalant blends of polyacrylic acid and polycarboxylates available on the open marketplace. Typical concentrations are 35 percent by weight as one of the other polymers or blends. Some antiscalants also include NaOH and surfactants.

FIG. 9 shows an alternative embodiment of the present invention that can be utilized when production water 10 is high in oil and boron, but low in silica and TDS. FIG. 9 shows a polyol soaked pre-activated carbon filter 416 containing pre-activated charcoal which has previously been soaked in a solution of one or more polyols selected from the group of D-mannitol, sorbitol, n-methyl-D-glutamine (nmDg) and xylitol for a sufficient period of time to saturate the pre-activated charcoal with the polyol solution. The boric acid present in the production water 10 will complex with the polyols present in the pre-activated charcoal. The resulting larger borate-polyol complexes are then absorbed by the pre-activated charcoal along with the remaining trace oil in the production water 10. In this embodiment, no reverse osmosis is required since the total dissolved solids are low.

Alternatively or additionally, ground nutshells can also be soaked in one or more of the polyols selected from the group of D-mannitol, sorbitol, n-methyl-D-glutamine (nmDg) maltitol, lactitol, erythritol, isomalt and xylitol and then placed in a polyol soaked nutshell filter 406. The resulting larger borate-polyol complexes will be filtered in part by the nutshell filter 106 and absorbed in part by the polyol soaked pre-activated charcoal.

While there have been shown what are presently considered to be preferred embodiments of the present invention, it will be apparent to those skilled in the art that various changes and modifications can be made herein without departing from the scope and spirit of the invention.

I claim:

1. A method of treating production water having inorganic and organic undissolved solid particulates, oil content of more than 1 ppm, TDS of more than 600 ppm, and boron greater than 2 ppm, comprising the following steps in the order named of:
(a) filtering said inorganic and organic undissolved solid particulates to less than 2 microns in size using a combination of one or more filters;
(b) passing said production water through a micro-oil droplet separator to reduce said oil content to less than 0.5 ppm;
(c) passing said production water through pre-activated charcoal;
(d) injecting into said production water one or more polyols selected from the group of D-mannitol, sorbitol, n-methyl-D-glutamine (nmDg), maltitol, lactitol, erythritol, isomalt or xylitol; and
(e) passing said production water through a reverse osmosis semi-permeable membrane.

2. The method of claim 1 wherein said filters of step (a) comprise a combination of one or more sock filters and one or more cartridge filters.

3. The method of claim 1 wherein said filters of step (a) comprise a combination of one or more sock filters and one or more pleated filters.

4. The method of claim 1 wherein step (d) is performed after step (b) and prior to step (c).

5. The method of claim 1 wherein said pre-activated charcoal comprises charcoal manufactured from nut shells and soaked in a solution of magnesium chloride hexahydrate.

6. The method of claim 1 wherein said pre-activated charcoal comprises charcoal manufactured from nut shells and soaked in a solution of ferric chloride.

7. The method of claim 1 wherein said polyols are injected at a molar ratio range of 1:1 to 10:1 polyol to boron.

8. The method of claim 1 wherein said pre-activated charcoal comprises charcoal manufactured from nut shells and soaked in a solution of polyols.

9. The method of claim 1 further comprising the step of cooling said production water to a temperature of less than 112° F.

10. A method of treating production water having inorganic and organic undissolved solid particulates, oil content of more than 1 ppm, TDS of more than 600 ppm, and boron greater than 2 ppm, comprising the following steps in the order named of:
(a) filtering said inorganic and organic undissolved solid particulates to less than 2 microns in size using a combination of one or more filters;
(b) passing said production water through a micro-oil droplet separator to reduce said oil content to less than 0.5 ppm;
(c) passing said production water through pre-activated charcoal, said pre-activated charcoal previously soaked in a polyol selected from the group of D-mannitol, sorbitol, n-methyl-D-glutamine (nmDg) maltitol, lactitol, erythritol, isomalt or xylitol; and
(d) passing said production water through a reverse osmosis semi-permeable membrane.

11. The method of claim 10 wherein said pre-activated charcoal comprises charcoal manufactured from wood.

12. The method of claim 10 where said pre-activated charcoal comprises charcoal manufactured from nut shells.

13. The method of claim 12 wherein said nut shells are coconut shells.

14. The method of claim 10 further comprising the step of cooling said production water to a temperature of less than 112° F.

15. A method of treating production water having inorganic and organic undissolved solid particulates, oil content of more than 1 ppm, TDS of more than 600 ppm, boron greater than 2 ppm, and silica greater than 60 ppm comprising the following steps in the order named of:
(a) filtering said inorganic and organic undissolved solid particulates to less than 2 microns in size using a combination of one or more filters;
(b) passing said production water through a micro-oil droplet separator to reduce said oil content to less than 0.5 ppm;
(c) passing said production water through pre-activated charcoal;
(d) injecting into said production water one or more polyols selected from the group of D-mannitol, sorbitol, n-methyl-D-glutamine (nmDg) maltitol, lactitol, erythritol, isomalt, or xylitol;
(e) reducing said silica in said production water to below 30 ppm; and
(f) passing said production water through a reverse osmosis semi-permeable membrane.

16. The method of claim 15 wherein step (n) is accomplished by injecting sodium aluminate into the production water on a molar ratio range of 2:1 to 6:1 said sodium aluminate to said silica in order to form a precipitate and filtering said precipitate through mechanical separation.

17. The method of claim 15 wherein step (n) is accomplished by passing said production water through a diatomaceous earth filter, said diatomaceous earth filter having electro-positive diatomaceous earth with a coating of aluminum-hydroxide.

18. The method of claim 15 wherein step (n) is accomplished by injecting an antiscalant into the production water.

19. The method of claim 1 wherein said filters of step (a) comprise a combination of one or more sock filters and one or more cartridge filters.

20. The method of claim 1 wherein said filters of step (a) comprise a combination of one or more sock filters and one or more pleated filters.
